(19) United States
(12) Patent Application Publication
(10) Pub. No.: US 2022/0312787 A1
(43) Pub. Date: Oct. 6, 2022

(54) ACCOUSTIC CHEESE WHEEL RIPENING SYSTEM AND METHOD

(71) Applicant: TOTONDO S.R.L., Bologna (BO) (IT)

(72) Inventor: Gianluca FRANZONI, Bologna (BO) (IT)

(21) Appl. No.: 17/298,516

(22) PCT Filed: Dec. 16, 2019
(86) PCT No.: PCT/IB2019/060854

§ 371 Date: May 28, 2021

(30) Foreign Application Priority Data
Dec. 14, 2018 (IT) 102018000011138

(51) Int. Cl. A23C 19/14; G10K 11/34; A01J 25/16

(52) U.S. Cl. CPC A23C 19/14; G10K 11/343; A01J 25/162

(57) ABSTRACT

Method for producing ripened hard or semi-hard cheese comprising the steps of: i) arranging one or more unripened cheese wheels (2) comprising phosphoproteins and lactic bacteria in a maturation environment (10); ii) providing at least one electro-acoustic transducer (6) configured to generate sound waves (4) in the maturation environment (10), at a time-varying frequency and at a sound pressure comprised in the range from 50-100 dB_{SPL}; iii) for a treatment time, stimulating the at least one cheese wheel (2) of step i) with said sound waves (4) to accelerate a proteolysis of phosphoproteins by lactic bacteria; (iv) ripening the cheese wheel (2) for a ripening time to obtain a ripened cheese wheel (2). The present invention also regards a cheese wheel obtained using such method, and a production system.

The present invention regards a method and a system for producing ripened hard or semi-hard cheese, and a cheese wheel obtained through such method.

It is known that the cheese maturation process is an extremely slow process, and is of fundamental importance so that the curd can transform and break down in order to develop desired characteristics in terms of consistency, aroma, taste, etc.

Nevertheless, the lamented slow maturation slow pace leads to inescapable drawbacks.

By way of example, high labour costs are required to turn the cheese wheels and brush the surface to remove mould and bacteria.

By way of further example, the permanence of cheese in the maturation cellar for a long time represents a high cost of immobilisation of the capital.

Prior document EP 0477774 A1 discloses a method for producing fermented or matured foods using vibrations. In this prior document said vibrations must be able to provide “1/f fluctuations” so as to increase the activity of yeasts in such foods, to improve their taste and to act on their water molecules.

The prior document “Käse beschallen”, (https://hkbgehtanland.ch/assets/pdf/20181129_hkb_kaese-beschallen_factsheet.pdf), by anonymous author, illustrates an experiment between sound and culinary that poses the question whether sound waves can affect the cheese metabolism. However, this question remains unanswered in this prior art document.

It would therefore be desired that the ripening of the cheeses be accelerable with respect to the conventional times, without however causing a reduction or loss of the organoleptic properties or of the quality level of the cheese.

Thus, the present invention falls within the scope of this previous context, proposing to provide a method and a system in which the proteolytic process of the unripened cheese wheels is accelerated through the use of sound waves at a given sound pressure.

As a matter of fact, the inventors of the present invention discovered that cheese wheels treated with sound waves (and in particular with music, advantageously classical music) for at least a part of their ripening period, undergo accelerated proteolysis of the phosphoproteins by lactic bacteria, and therefore they mature at generally lesser ripening times.

This objective is achieved through a method according to claim 1, by means of a cheese wheel according to claim 10, and by means of the system according to claim 11. The claims dependent on the aforementioned claims show advantageous or preferred embodiments.

The object of the present invention will now be illustrated based on of the attached drawing, provided solely by way of non-limiting example.

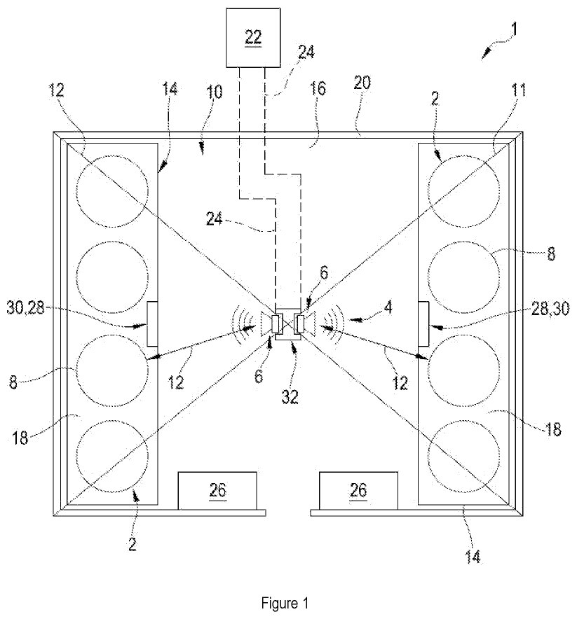

FIG. 1 shows a schematic plan view of a system, subject of the present invention, according to a possible embodiment.

It should be pointed out that the variant of FIG. 1 is solely a schematisation, not to scale, hence the dimensional ratios between the parts or elements discussed below could be very different from the variant shown.

The aforementioned objectives are achieved through a method for producing ripened—hard or semi-hard cheese comprising the steps of:

(i) placing one or more unripened cheese wheels 2 comprising phosphoproteins and lactic bacteria (or ferments) in a maturation environment 10;
ii) providing at least one electro-acoustic transducer 6 configured to generate sound waves 4 in the maturation environment 10, at a time-varying frequency and at a sound pressure comprised in the range from 50-100 dB_{SPL} (equal to 6.32-2000 mPa);
iii) for a treatment time, stimulating the at least one cheese wheel 2 of step i) with aforementioned sound waves 4 to accelerate a proteolysis of phosphoproteins by lactic bacteria;
(iv) ripening the cheese wheel 2 for a ripening time, specifically in order to obtain a ripened cheese wheel 2.

It should be observed that, within the present description, the expression “unripened” means a cheese wheel which has not begun, or which has begun but not yet completed, the maturation thereof. Considering for example a wheel of Parmigiano Reggiano, this wheel can be deemed unripened from the moment when the “salting” step ended (i.e. after its period of stay in brine).

In the present description, the expressions “phosphoproteins” and “lactic bacteria” are used to indicate proteins and bacteria conventionally used in the dairy industry. According to one embodiment, the phosphoproteins comprise or consist of one or more caseins, for example selected from among the group consisting of casein α1, α2, β, γ, κ and mixtures thereof.

The term “electro-acoustic transducer” is used to indicate a device capable of converting an electrical signal into a sound wave. For example, in one embodiment, the electro-acoustic transducer comprises at least one loudspeaker. According to different embodiments, the electro-acoustic transducer could be of the magnetodynamic, electrodynamic, electrostatic, piezoelectric or plasma type.

In the present description the symbol “dB_{SPL}” will be used to indicate the tenth part of the bel, the logarithmic unit of the pressure ratio indicating—in acoustics—the sound pressure level (SPL).

For the sake of completeness, each time a numerical value expressed as “dB SPL” is indicated, also indicated will be the corresponding pressure value expressed in milliPascal (mPa; Equivalent to one thousandth of Newton per square meter), derived unit of the International System, such pressure value in mPa being calculated considering an atmospheric pressure of 101,325 Pa.

The expression “treatment time” will instead be used to indicate a period of time during which the sound waves 4 affect, and impact, the cheese wheel 2, and which involves at least a part of the “ripening time” (the latter being the time that elapses between a “unripened” condition and a “ripened” condition of the cheese wheel).

In other words, the treatment time of step iii) could overlap and involve even only a part of the ripening time of step iv), i.e. only a part of the period preceding the ripened condition of the cheese.

Nevertheless, according to advantageous embodiments, the treatment time is mainly, or substantially completely, overlapped with the ripening time.

As regards the expression conventional “ripening time” or the degree of ripening to be used for the different types of cheese in the absence of the present invention, reference should be made to the knowledge typical of the dairy industry.

According to an embodiment, the sound pressure is comprised in the range from 70-90 dB_{SPL} (63.25-632.46 mPa), optionally in the range from 80-90 dB_{SPL} (200-632.46 mPa), advantageously in the range from 83-87 dB_{SPL} (282.51-447.74 mPa), for example being substantially 85 dB_{SPL} (355.66 mPa); According to a further embodiment, the time-varying frequency is comprised the range from 101 Hz-1 kHz.

According to an even further embodiment, the ripening time according to the invention is equal to or less than 24 months, optionally equal to or less than 18 months, advantageously equal to or less than 15 months, for example about 5-13 months.

According to an embodiment, the treatment time and the ripening time substantially coincide, so that the stimulus with the sound waves 4 of step iii) is substantially uninterrupted over the entire ripening time of step iv).

The term “substantially uninterrupted” will be used to indicate a treatment time coinciding with the ripening time, except for any interruptions in the emission of sound waves for technical or technical-production reasons (for example due reasons regarding the maintenance of the electro-acoustic transducer, or for brushing and/or turning the wheels).

According to a preferred variant, the treatment time and the curing time are adjusted so as to calibrate a reduced crust thickness 8 of the cheese wheel 2, by virtue of a lesser degree of drying of said crust 8, with respect to a crust thickness obtained in a “conventional” ripening time (i.e.: in the absence of sound waves) lasting at least twice as much for a cheese wheel of the same size.

In other words, the calibration of the thickness of the crust 8 can be carried out by means of an accurate setting of the treatment time and the ripening time.

Such selection shall in particular account for the following factors:

(a) the degree of drying (and thus the thickness) of the crust shall thus increase proportionally to the longer duration of the ripening time; and
b) on the other hand, the ripening time shall reduce proportionally to the longer duration of the treatment time.

Hence, by setting the aforementioned times, it is possible not only to reduce the thickness of the crust considering the same ripening time, but also to reduce this crust even for ripening times with using the conventional ripening which are at least twice as much (or at least three times as much) with respect to an accelerated ripening according to the present invention.

Without this being considered in any way limiting, the inventors of the present invention have proven that a cheese wheel ripened for about 12 months according to the present invention has the same maturation characteristics (for example, in terms of soluble nitrogen indices and proteolysis indices) of a cheese wheel ripened for about 36 months using the conventional system.

According to some embodiments, the maturation environment 10 has an average temperature comprised in the range from 10-20° C., and/or a humidity comprised in the range from 80-90%.

According to a variant, the propagation of the sound waves 4 from the electro-acoustic transducer 6 to the cheese wheel 2 (or to the plurality thereof) takes place in air, preferably at atmospheric pressure.

According to a further variant, the length of the propagation path 12 is equal to or greater than about 1 metre.

According to an even further embodiment, the length of the propagation path 12 could be equal to or less than 5 metres.

According to a particularly preferred embodiment, the sound waves 4 are part of a music track, advantageously a classical music track.

In the wide range of composers of classical music, such composers may comprise—by way of non-limiting example—Wolfgang Amadeus Mozart, Sebastian Bach and Ludwig van Beethoven whose tracks have been used in the examples outlined below.

The aforementioned examples are also achieved by means of a ripened cheese wheel 2 obtained by means of the method according to any one of the embodiments outlined above.

Lastly, the aforementioned objectives are achieved by means of a system 1 for producing ripened—hard or semi-hard cheese.

Given that this system is advantageously used to implement the method described above, it should be observed that, even if not explicitly expressed, such system may contain any preferred or accessory characteristic implicitly or explicitly deducible of the description outlined above.

Such system 1 comprises a maturation environment 10, arranged in which are means 14 for supporting one or more unripened cheese wheels 2, and at least one electro-acoustic transducer 6 configured for generating sound waves 4 in the maturation environment 10—at a time-varying frequency and at a sound pressure comprised in the range from 50-100 dB_{SPL} (6.32-2000 mPa).

According to a possible embodiment, the support means 14 comprise one or more decks (or shelves) 18 supporting one or more cheese wheels 2 each.

For example, the support means 14 could comprise a plurality of vertically superimposed decks 18.

The electro-acoustic transducer 6 is arranged so as to stimulate—for a treatment time—the at least one cheese wheel 2 with the sound waves 4, in order to obtain ripened cheese wheels 2 at the end of a ripening time.

According to a first embodiment, the electro-acoustic transducer 6 is arranged at least partly in the maturation environment 10.

According to a second embodiment, the electro-acoustic transducer 6 is arranged in an approximately central area of the maturation environment 10, for example as schematised by the intersected diagonals D1, D2 schematised in FIG. 1.

According to a third embodiment, the electro-acoustic transducer 6 is arranged outside the maturation environment 10, but in a manner such that the sound waves 4 can stimulate the cheese wheels 2 in any case.

According to a fourth embodiment, one or more transducers could be recessed (partly or fully) into a partitioning wall or a lateral wall 20 delimiting at least part of the maturation environment 10.

According to a fifth embodiment, one or more transducers could be arranged approximately frontally with respect to the cheese wheels 2, or frontally with respect to the support means 14.

In any case, as is well exemplified by the previous variants, irrespectively of the arrangement of the electro-acoustic transducer with respect to the maturation environment, it is essential that the sound waves reach cheese wheel or the plurality of cheese wheels, for example in a direct or reflected manner. According to a variant, the electro-acoustic transducer 6 is arranged at a height comprised in the range from 0.1-5 meters, for example comprised in the range from 0.5-3 meters, with respect to a ground surface 16 of the maturation environment 10.

According to a further variant, the electro-acoustic transducer 6 could be supported by a support structure 32, in particular of the fixed or movable type.

According to an even further variant, the support structure 32 could be mounted on rolling means, so as to make it slidable on, and/or with respect to, the ground surface 16.

According to an advantageous variant, the propagation of the sound waves 4 from the electro-acoustic transducer 6 to the cheese wheel 2 or to the plurality of cheese wheels takes place in air, advantageously at atmospheric pressure.

According to a further advantageous variant, the propagation of the sound waves 4 outside the electro-acoustic transducer 6 takes place in the absence of physical or mechanical hindrances which are interposed before such waves reach the at least one cheese wheel 2.

According to an embodiment, the sound pressure is comprised in the range from 70-90 dB_{SPL} (63.25-632.46 mPa), optionally in the range from 80-90 dB_{SPL} (200-632.46 mPa), advantageously in the range from 83-87 dB_{SPL} (282.51-447.74 mPa), for example being substantially 85 dB_{SPL} (355.66 mPa).

According to another embodiment, the time-varying frequency is comprised in the range from 101 Hz-1 kHz.

According to a further embodiment, the electro-acoustic transducer 6 is actuated for at least part of the ripening time.

It should be observed that the actuation time of the electro-acoustic transducer 6 is substantially similar to the treatment time addressed above.

According to a further embodiment, the electro-acoustic transducer 6 is actuated for a main or substantially complete part of the ripening time.

According to a further embodiment, the electro-acoustic transducer 6 is actuated substantially uninterruptedly over the entire ripening time.

As regards the definition of “substantially uninterrupted”, reference shall be made to the definition outlined above.

With regard to the actuation of the electro-acoustic transducer 6, the system 1 could comprise at least one source of electrical signals 22 functionally connected to the transducer 6 or to the plurality thereof.

For example, the connection between the source 22 and the at least one electro-acoustic transducer 6 could be obtained in wireless mode, or through one or more electrical conductors 24.

According to various embodiments, the source of electrical signals 22 could comprise a generator and/or a signal amplifier.

According to further embodiments, the maturation environment 10 has an average temperature comprised in the range from 10-20° C., and/or a humidity comprised in the range from 80-90%.

In this regard, in an embodiment, the system 1 could comprise air conditioning means 26 for the maturation environment. For example, the air-conditioning means could comprise a heating-cooling unit, and/or a humidity adjustment unit.

Optionally, the system could comprise means 28 for detecting the temperature and/or means 30 for detecting the humidity in the maturation environment 10, functionally connected to the air conditioning means 26 in order to adjust said parameters in such environment.

By way of example, some experimental tests on the efficacy of the present method with respect to a conventional ripening system will be outlined hereinafter.

### EXAMPLE 1: METHODOLOGY USED

Three maturation environments (specifically: maturation cellars)—distinguished by letters A, B, C—of the same size and rectangular in plan view, were each equipped with an electro-acoustic transducer.

The electro-acoustic transducer used is a BOSE®, SoundTouch® Wave Music System loudspeaker.

The electro-acoustic transducer is arranged approximately centrally, at the intersection of the diagonals D1, D2, at a height of approximately 1.5 meters from the ground surface.

The size of each environment is 5 meters long, 3 meters wide, and 2.5 meters high.

A control maturation environment—marked with letter D—of the same size and plan as environments A, B, C—is without an electro-acoustic transducer.

Each maturation environment is provided with eight decks in total, whereas four decks are arranged on each of the two long sides, the decks of the same side are mutually superimposed, each deck being about 60 centimetres deep.

Arranged on the decks are unripened hard cheese wheels, weighing about 5 kg each, in particular 12 cheese wheels for each deck, for a total of 96 wheels for each maturation environment.

The electro-acoustic transducer is actuated 24 hours a day, 365 days a year, with a control of the sound pressure of the diffused music, and of the frequency.

The music tracks were selected to comply with the pressure and frequency of the invention, and they are played in loop mode.

The selected tracks were by Wolfgang Amadeus Mozart for the maturation environment A, Sebastian Bach for environment B, Ludwig van Beethoven for environment C.

### EXAMPLE 2: ANALYSIS OF THE CHEESE WHEELS OF THE WHEELS OF EXAMPLE 1

The effects of sound waves were tested experimentally by periodically analysing the wheels in the different cellars A-D, in particular by analysing the peroxide number, the fat acidity, the total nitrogen, the soluble nitrogen and the proteolysis index values.

The cheese wheels were tasted periodically.

Table 1 below summarises the results of the analyses conducted at a treatment time coinciding with a 12-month ripening time:

TABLE 1

| Maturation environment | A | B | C | D |
|---|---|---|---|---|
| Peroxide number | 1.8 | 1.8 | 1.8 | <1 |
| Acidity (pH) | 3.51 | 3.51 | 3.51 | 1.18 |
| Total nitrogen (%) | 5.40 | 5.40 | 5.40 | 4.46 |
| Soluble nitrogen (%) | 1.30 | 1.30 | 1.30 | 0.75 |
| Proteolysis index | 0.24 | 0.24 | 0.24 | 0.17 |

From a comparison of the analyses conducted in relation to the maturation environments A, B, C it can be deduced that the type of musical track used has no significant influence on the seasoning of the cheese, without prejudice to the variable frequency and sound pressure conditions specified above.

However, with respect to the cheese wheels contained in the control maturation environment D (without electro-acoustic transducer), it was observed that the cheese wheels ripened according to the invention uniformly showed better indices of soluble nitrogen, and proteolysis indices higher by about 40%. Moreover, by tasting, it was found that the cheese wheels ripened in the maturation environments A, B, C had a more advanced organoleptic profile, with notes of dried fruit and spices, and with a pleasantness to the palate (umami) typical of cheese wheels ripened for over 30 months through conventional ripening. Also observed was a reduction (up to 80%) in the brushing frequency of the surface of the cheese wheels, as well as a drastic reduction in the ripening time.

The latter factor allowed to increase the yield in edible cheese, since the thickness of the crust in the ripened cheese wheels according to the present invention was much lower (less than 50%) than in cheese wheels of equal ripening, but obtained over drastically longer times through conventional ripening (in the absence of sound waves).

Innovatively, the present invention is capable of overcoming the drawbacks linked to the prior art.

More precisely, the use of sound waves at the specified pressure allows to accelerate the proteolysis of phosphoproteins, in order to achieve shorter maturation times with respect to the conventional ripening.

In this manner, man-hours required to turn and brush the cheese wheels can be reduced, same case applying to the capital immobilisation costs which are also lower.

Although the mechanism of action of sound waves on bacteria or lactic ferments has not yet been clarified, the effectiveness of the acoustic stress provided for by the present system is present and it was also proven experimentally (as outlined above).

Advantageously, the system and method of the present invention allow to obtain improvement effects of physical-chemical and organoleptic nature on cheese wheels, not only by virtue of the arrangement of the transducers.

Advantageously, the system and method of the present invention use acoustic pressures that do not involve the entire range of the audible sound, but a range specially selected to maximise the effects of acceleration by means of sound waves.

Advantageously, the system and method of the present invention make the cheese wheels suitable for use as grated cheese already in 12 months, with higher yields.

According to a further advantageous aspect, the lower crust thickness allows to drastically increase the yield, with the same amount of cheese curd in the unripened cheese wheels.

The embodiments of the system, the cheese wheel and the method can be subject—by a man skilled in the art—of substitutions or changes regarding the described characteristics according to the contingencies. These variants are also to be considered included in the scope of protection as outlined in the claims that follow.

Furthermore, it should be observed that any embodiment may be implemented independently from the other embodiments described.

### LIST OF REFERENCE NUMBERS

1 system
2 cheese wheel
4 sound waves
6 electro-acoustic transducer
8 crust
10 maturation environment
12 propagation path
14 support means
16 ground surface
18 deck or shelf
20 partitioning wall or lateral wall
22 source of electrical signals
24 electrical conductor
26 air conditioning means
28 temperature detection means
30 humidity detection means
32 support structure
D1 diagonal
D2 diagonal

1. Method for producing ripened—hard or semi-hard—cheese comprising the steps of:
(i) placing one or more unripened cheese wheels (2) comprising phosphoproteins and lactic bacteria in a maturation environment (10);
ii) providing at least one electro-acoustic transducer (6) configured to generate sound waves (4) in the maturation environment (10), at a time-varying frequency and at a sound pressure comprised in the range from 50-100 dB_{SPL} (6.32-2000 mPa);
iii) for a treatment time, stimulating the at least one cheese wheel (2) of step i) with said sound waves (4) to accelerate a proteolysis of phosphoproteins by lactic bacteria;
(iv) ripening the cheese wheel (2) for a ripening time in order to obtain a wheel of ripened cheese (2);
wherein the propagation of the sound waves (4) from the electro-acoustic transducer (6) to the cheese wheel (2) or to the plurality thereof occurs in the air, the length of the propagation path (12) being equal to or greater than 1 metre.

2. The method according to claim 1, wherein the sound pressure is comprised in the range from 70-90 dB_{SPL} (63.25-632.46 mPa), optionally in the range from 80-90 dB_{SPL} (200-632.46 mPa), advantageously in the range from 83-87 dB_{SPL} (282.51-447.74 mPa), for example being substantially 85 dB_{SPL} (355.66 mPa).

3. The method according to claim 1, wherein the time-varying frequency is comprised in the range from 101 Hz-1 kHz.

4. The method according to claim 1, wherein the treatment time and the ripening time are mutually adjusted so to calibrate a reduced crust thickness (8) of said cheese wheel (2) by virtue of a lesser degree of drying of said crust (8); with respect to a crust thickness obtained in a conventional ripening time—in the absence of sound waves (4)—lasting at least twice as much for a cheese wheel of the same size.

5. The method according to claim 1, wherein the ripening time is equal to or less than 24 months, optionally equal to or less than 18 months, advantageously equal to or less than 15 months, for example about 5-13 months, and wherein the treatment time at least partly mainly or substantially fully overlaps with the ripening time.

6. The method according to claim 1, wherein the maturation environment (10) has an average temperature comprised in the range from 10-20° C., and a humidity comprised in the range from 80-90%.

7. The method according to claim 1, wherein said length of the propagation path (12) is equal to or less than 5 metres.

8. The method according to claim 1, wherein the sound waves (4) are part of a classical music track, for example by composers Wolfgang Amadeus Mozart, Sebastian Bach or Ludwig van Beethoven.

9. The method according to claim 1, wherein the phosphoproteins comprise or consist of one or more caseins, selected from among the group consisting of casein α1, α2, β, γ, κ and mixtures thereof.

10. A cheese wheel (2) obtained through the method according to claim 1.

11. A system (1) for producing ripened—hard or semi-hard cheese according to the method of claim 1, wherein said system comprises:
(i) a maturation environment (10) arranged in which are means (14) for supporting one or more unripened cheese wheels (2);
ii) at least one electro-acoustic transducer (6) configured to generate sound waves (4) in the maturation environment (10), at a time-varying frequency and at a sound pressure comprised in the range from 50-100 dB_{SPL} (6.32-2000 mPa);
wherein the electro-acoustic transducer (6) is arranged so as to stimulate for a treatment time the at least one cheese wheel (2) with said sound waves (4), in order to obtain a ripened cheese wheel (2) at the end of a ripening time;
wherein the propagation of the sound waves (4) from the electro-acoustic transducer (6) to the cheese wheel (2) or to the plurality thereof occurs in the air, the length of the propagation path (12) of the sound waves (4) being equal to or greater than 1 metre.

12. The system according to the claim 11, wherein:
the sound pressure is comprised in the range from 70-90 dB_{SPL} (63.25-632.46 mPa), optionally in the range from 80-90 dB_{SPL} (200-632.46 mPa), advantageously in the range from 83-87 dB_{SPL} (282.51-447.74 mPa), for example being substantially 85 dB_{SPL} (355.66 mPa);
the time-varying frequency is comprised in the range from 101 Hz-1 kHz;
the electro-acoustic transducer (6) is actuated in a substantially uninterrupted manner over the entire ripening time;
the ripening time is equal to or less than 24 months, optionally equal to or less than 18 months, advantageously equal to or less than 15 months, for example about 5-13 months;
the maturation environment (10) has an average temperature comprised in the range from 10-20° C., and a humidity comprised in the range from 80-90%;
the length of the propagation path (12) of the sound waves (4) is equal to or less than 5 metres;
the electro-acoustic transducer (6) is arranged in an approximately central area of the maturation environment (10);
and/or
the electro-acoustic transducer (6) is arranged at a height comprised in the range from 0.1-5 meters, for example comprised in the range from 0.5-3 meters, with respect to a ground surface (16) of the maturation environment (10).
